(19) United States
(12) Patent Application Publication
(10) Pub. No.: US 2020/0048589 A1
(43) Pub. Date: Feb. 13, 2020

(54) GARMENT LAUNDERING SYSTEM

(71) Applicant: Conopco, Inc., d/b/a UNILEVER, Englewood Cliffs, NJ (US)

(72) Inventors: Deborah Jane Cooke, Merseyside (GB); Helen Elspeth Lyon, Merseyside (GB)

(21) Appl. No.: 16/485,532

(22) PCT Filed: Feb. 7, 2018
(86) PCT No.: PCT/EP2018/053030

§ 371 Date: Aug. 13, 2019

(30) Foreign Application Priority Data
Feb. 13, 2017 (EP) 17155838.0

(51) Int. Cl. C11D 17/04; C11D 3/00; C11D 3/37; C11D 3/50; C11D 11/00; C11D 17/00

(52) U.S. Cl. CPC C11D 17/046; C11D 3/0015; C11D 17/0043; C11D 3/50; C11D 11/0017; C11D 3/373

(57) ABSTRACT

An anti-aging laundering system for fabrics comprising complementary laundering system components (a) a detergent composition, (b) a fabric rinse conditioner, and (c) an ancilliary laundry agent wherein the (b) or (c) provides a combination of (i) a fabric shape retention agent (ii) a fabric drape improver, and (iii) at least one perfume, and wherein said complementary laundering components bear common visual indicia and corresponding instructions to launder fabrics with components (a) and (b) and (c).

The present invention relates to an anti-aging laundering system and method for garments. In particular, but not exclusively, the invention relates to an anti-aging system and method for laundering garments which have a specific and essential combination of qualities whereby the loss or degradation of these qualities signal aging to the consumer thereby reducing utility of the garment.

Certain garments, such as fashion, formal or evening wear often have a specific and essential combination of shape and drape qualities. Drape is the term used to describe the way a fabric hangs under its own weight. Shape is the term used to describe the way a fabric reacts under mechanical stress i.e. stretching. Additionally, colour also impacts the appearance in that the perceived colour depends on the lighting and angle of the fabric. The specific combination of these features has an important bearing on how good a garment looks in use upon the human body. If one or more of these qualities are diminished or lost, this can signal aging of a garment to the consumer even while other qualities are maintained. Whereas some aging may be acceptable even desirable for some garments such as casual denim, other types, e.g. fashion, formal or evening wear merely look shabby and unwearable.

Cleaning of such special garments poses difficulties for consumers because these may be deleteriously affected by repeated washing.

One simple solution for such special garments is to use a professional cleaning service for special garment each time it needs cleaning. However for many consumers this is too expensive and/or time consuming and they prefer/need to wash such garments at home.

Home washing may pose a problem as repeated use of some home laundering products can deleteriously affect the shape/drape/colour quality of special garments over time. What may have been an expensive and treasured garment, is then often discarded after only a few washes.

Certain conditioning products offer ‘care’ benefits, however, even if these are used, if the garment already been treated by a less than optimum product in a prior laundering step e.g., (or in a subsequent step), the ‘care’ benefits may not be appreciable. For example, if the consumer selects a high performance cleaning product this may contain harsher cleaning components such that the conditioners/care agents used in latter stages of the wash cycle may not be able to reverse the earlier damage. On the other hand if the consumer selects a poor cleaning product, this may not remove soils, odours effectively.

All-in-one laundry products prevent ‘bad’ choices but are inevitably a compromise as the inclusion of both cleaning and conditioning/care components in a single composition can present difficulties for the formulator arising from the need to avoid undesirable interaction between certain chemicals in the composition during storage. Such interactions could result in instability of the composition on storage, or a reduction in the efficacy of certain components in the wash cycle. This can have an especially deleterious effect on special fabrics. Laundry kits go some way to preventing some ‘bad’ combinations but known kits still allow the consumer a choice for example of bleaching agents and colour restoring agents which if used together may not be optimal, especially for special/delicate fabrics.

Such problems can make laundering special garments seem intimidating, as poor choices can lead to poor performance, waste or damage. In extreme cases, favourite items of clothing can be ruined. Faced with such problems, some consumers delay washing which can mean the fabrics are left in laundry bins for extended periods which not optimal.

US 2008/009432 discloses a laundry system having unitized dosing. Compositions, articles and methods are provided for supplying fabric care benefits to clothing or fabrics in an automated washing machine and by manual washing. Laundry kits containing a variety of such articles and instructions concerning their use are disclosed.

The present invention seeks to address one or more of the problems identified in the prior art.

As used herein, “unit dose” means an amount of fabric care composition suitable to treat one load of laundry, such as from about 0.05 g to about 100 g, or from 10 g to about 60 g, or from about 20 g to about 40 g.

In a first aspect the invention provides an anti-aging laundering system for fabrics comprising complementary laundering system components:

(a) a detergent composition,

(b) a fabric rinse conditioner,

(c) an ancilliary laundry agent

wherein (b) or (c) provides a combination of:

(a) a fabric shape retention agent

(b) a fabric drape improver, and

(c) at least one perfume

wherein said laundering components bear common visual indicia and corresponding instructions to launder fabrics with components (a) and (b) and (c).

As used herein “complementary” means that each component complements other components for the sake of the purpose of fabric anti-aging.

Preferably the system further includes complementary laundering system component (d) a fabric refresh spray which also bears said common visual indicia.

Preferably the laundering system includes instructions to treat the fabrics with (d) the fabric refresh spray following use of said laundered fabrics, and then subsequently to re-wear.

Preferably the components (b) and (c) of the ant-aging system further include at least one colour care agent. Having regard for the complementary nature of the system, where colour care agents are uses, whitening agents may not be present in the system.

In a further aspect the invention provides a method of laundering fabrics using a laundering system comprising as defined above, the method comprising the steps of:

(i) carrying out an aqueous washing operation in which components (a), (b) and (c) are added to the wash liquor.

Preferably the method further comprises the subsequent step of

(ii) refreshing the laundered fabrics after use with refresh spray (d).

With this arrangement, consumers are provided with a dedicated anti-aging system and so can ensure delicate garments undergo a complete wash cycle at home, over repeated washes, so that fabrics can be properly cleansed but also enjoy renewal of multiple essential properties, in particular shape and drape and preferably also colour. Thus, garments can be used more often, and will remain in use for longer. The user can extend the wear time by using a refresh spray of the system, perhaps after wearing for a short period of time where little soiling has occurred, after which the garment can be used and then washed again. Furthermore both preventative and restorative anti-aging components may be included, without the problem of formulating these together but without the consumer needing to make the correct combination and sequence of products.

Preferably the fabric is a garment.

Preferably the system components (a), (b), (c) and also preferably (d) are provided in an outer packaging which at least visually but preferably physically connects the components but more preferably wholly or partly encloses said components.

The outer packaging may comprise a box, bag, pouch or a wrapper/tape by which the products may be tied or taped together. Preferably the outer package has a flat base so that it can be placed on a countertop or similar for ease of access as a complementary, co-ordinated system. For example, it may be placed on a countertop in a kitchen or utility room, or may be placed on top of a washing machine.

Preferably the outer packaging is a box in which the system components are arranged in a layered or nested configuration. Such an arrangement provides for stability in transport and postal delivery of a complete laundering system to the consumer. The consumer may then conveniently order via the internet where such websites bear similar and have the system delivered to their home.

The detergent composition may be in any suitable form such as liquid, gel, paste, powder, particles, flakes, etc. Preferably, however, the detergent composition comprises one or more unit doses. Said unit doses may comprise capsules, which may comprise water soluble film capsules containing the detergent composition. The capsule film may be flexible or rigid. In the case of rigid capsules, these may be injection moulded. The capsules may comprise one or more compartments to separate incompatible detergent composition ingredients. Alternatively or additionally different capsules may contain different ingredients. The provision of a capsule format is preferable because, if provided in a flexible packaging, such as a pouch, this can form a layer to stabilise any bottles used to contain other liquid components. Most preferable in this arrangement are rigid or semi-rigid capsules.

Preferably component (b), the fabric rinse conditioner, comprises at least 8 wt % of a fabric conditioning active. The fabric conditioning active may comprise a quaternary ammonium compound. The preferred quaternary ammonium fabric conditioner for use in compositions of the present invention are the so called “ester quats”. Particularly preferred materials are the ester-linked triethanolamine (TEA) quaternary ammonium compounds comprising a mixture of mono-, di- and tri-ester linked components. Typically, TEA-based fabric softening compounds comprise a mixture of mono, di- and tri-ester forms of the compound where the di-ester linked component comprises no more than 70% by weight of the fabric softening compound, preferably no more than 60 wt % of the fabric softening compound and at least 10% of the monoester linked component.

Preferred agents are preparations which are rich in the di-esters of triethanolammonium methylsulphate, otherwise referred to as “TEA ester quats”. Commercial examples include Stepantex™ UL85, ex Stepan, Prapagen™ TQL, ex Clariant, and Tetranyl™ AHT-1, ex Kao, (both di-[hardened tallow ester] of triethanolammonium methylsulphate), AT-1 (di-[tallow ester] of triethanolammonium methylsulphate), and L5/90 (di-[palm ester] of triethanolammonium methylsulphate), both ex Kao, and Rewoquat™ WE15 (a di-ester of triethanolammonium methylsulphate having fatty acyl residues deriving from C10-C20 and C16-C18 unsaturated fatty acids), ex Witco Corporation. Also, soft quaternary ammonium actives such as Stepantex VK90, Stepantex VT90, SP88 (ex-Stepan), Prapagen TQ (ex-Clariant), Dehyquart AU-57 (ex-Cognis), Rewoquat WE18 (ex-Degussa) and Tetranyl L190 P, Tetranyl L190 SP and Tetranyl L190 S (all ex-Kao) are suitable.

The fabric rinse conditioner may comprise fabric softening, anti-abrasion and anti-wrinkling components, silicone derivatives, such as polydimethylsiloxane and amino-functional silicones; oily sugar derivatives; dispersible polyolefins; polymer latexes; cationic surfactants and combinations thereof.

The fabric rinse conditioner may comprise microcapsules containing benefit agents. Preferably the fabric conditioner comprises microcapsules with different delivery profiles. For example, the capsules may comprise an outer wall and a core containing active material such as perfumes and the walls of different capsules have different properties. Having a mixture of encapsulates having different release profiles significantly increases the perfume perception during multiple stages of a laundry process.

The fabric conditioning active material may further include one or more malodour counteractants at a level preferably less than about 70 weight %, more preferably less than about 50 weight % of the composition. The malodour counteractant composition serves to reduce or remove malodor from the surfaces or objects being treated with the present compositions. The malodour counteractant composition is preferably selected from uncomplexed cyclodextrin, odor blockers, reactive aldehydes, flavanoids, zeolites, activated carbon, and mixtures thereof. Compositions herein that include odor control agents can be used in methods to reduce or remove malodor from surfaces treated with the compositions.

Specific examples of malodour counteractant composition components useful in the microcapsules herein include, but are not limited to, malodour counteractant components such as 1-cyclohexylethan-1-yl butyrate, 1-cyclohexylethan-1-yl acetate, 1-cyclohexylethan-1-ol, 1-(4′-methylethyl)cyclohexylethan-1-yl propionate, and 2′-hydroxy-1′-ethyl(2-phenoxy)acetate, each of which compound is marketed under the trademark VEILEX by International Flavors & Fragrances Inc. (New York, N.Y.); and malodour counteractant components such as those disclosed in U.S. Pat. No. 6,379,658, which include β-naphthyl methyl ether, β-naphthyl ketone, benzyl acetone, mixture of hexahydro-4,7-methanoinden-5-yl propionate and hexahydro-4,7-methanoinden-6-yl propionate, 4-(2,6,6-trimethyl-2-cyclohexen-1-yl)-3-methyl-3-buten-2-one, 3,7-dimethyl-2,6-nonadien-1-nitrile, dodecahydro-3a,6,6,9a-tetramethyl naphtho(2,1-b)furan, ethylene glycol cyclic ester of n-dodecanedioic acid, 1-cyclohexadecen-6-one, 1-cycloheptadecen-10-one, and corn mint oil.

Preferably the fabric conditioner is in liquid form, and is pourable into dispensing device.

Preferably the fabric rinse conditioner comprises one or more cellulase enzymes.

Preferably the cellulase comprises a cellulolytic enzyme (commonly known as a cellulase but not restricted to EC 3.1.2.4) active in restoring colour to fabrics by removal of cellulose fibrils (fuzz and pills) from the surface of the fabric.

Suitably the cellulases include endo-beta-1,4-glucanases, cellobiohydrolases and beta-1,4-glucosidases. The cellulases may be bacterial or fungal and from any family of glycosyl hydrolase showing cellulase activity. The cellulases include chemically modified or protein engineered mutants. The cellulase may be from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO89/09259.

Preferably cellulases are the alkaline or neutral cellulases having colour care benefits. For example the cellulases described in EP 0 495 257, EP 0 531 372, WO 96/11262, WO 96/29397, WO 98/08940, WO 94/07998, EP 0 531 315, U.S. Pat. Nos. 5,457,046, 5,686,593, 5,763,254, WO 95/24471, and WO 98/12307.

Commercially available cellulases include Celluzyme®, and Carezyme® (Novozymes NS), Clazinase®, Puradax® EG-L and Puradax® HA (Genencor International Inc.), and KAC®-500(B) (Kao Corporation).

The rinse conditioner may comprise from 0.000005% to 0.2%, preferably from 0.00001 to 0.05%, more preferably from 0.0001% to 0.02% by weight of the cellulase enzyme.

Preferably component (c), the ancilliary laundry agent comprises the fabric shape retention agent and fabric drape improver in the form of a fabric softening silicone.

Preferably the fabric softening silicone is functionalised such as alkyl (or alkoxy) functionalised silicones, and functionalised silicones or copolymers with one or more different types of functional groups such as amino, phenyl, polyether, acrylate, siliconhydride, carboxy acid, quarternized nitrogen and mixtures thereof.

An example of a commercially available anionic functional material are: X22-3701E from Shin Etsu and Pecosil PS-100 from Pheonix Chemical.

Preferably the ancillary laundry agent comprises the combination of a fabric softening silicone and a cationic polymer.

Preferably the cationic polymer is a cationic cellulose polymer i.e. a polymer having a cellulose backbone and an overall positive charge. The cationic cellulose-based polymers of the present invention have a modified cellulose backbone, modified in that additional chemical groups have been reacted with some of the free hydroxyl groups of the polysaccharide backbone to give an overall positive charge to the modified cellulose monomer unit.

Preferably the cationic cellulose polymers has a cellulose backbone modified to incorporate a quaternary ammonium salt. Preferably the quaternary ammonium salt is linked to the cellulose backbone by a hydroxyethyl or hydroxypropyl group. Preferably the charged nitrogen of the quaternary ammonium salt has one or more alkyl group substituents.

The ancilliary laundry agent suitably comprises:

(a) 2-30 w.t. % fabric softening silicone;

(b) Less than 5 w.t. % surfactant;

(c) 0.25-10 w.t. % cationic polymer

(d) Water

Preferably the functionalised fabric softening polymer and cationic cellulose polymer are present in a ratio of 5:2 to 1:6 by weight.

The ancillary composition may comprise a serum referring to a specific format of laundry product. This is a liquid product which is used in addition to the laundry detergent and/or the fabric conditioner to provide an additional or improved benefit to the materials in the wash or rinse cycle. A serum is defined by its physical interaction with laundry components (a) detergent and (b) fabric conditioner, in liquid form. A serum will float on the laundry liquid with which it is designed to be used.

Preferably the viscosity of the laundry serum composition is greater than the viscosity of a laundry liquid with which it is used, more preferably 500 Pa·s greater than a laundry liquid with which it is used. The higher viscosity prevents mixing of the laundry serum composition and laundry liquid and provides the benefit that the entire serum composition is carried into the wash or rinse with the laundry liquid.

The viscosity of the laundry composition is preferably 400-15000 Pa·s. This viscosity provides the benefit that the laundry liquid carries the serum into the laundry process. Preferably, the serum floats on a, laundry liquid with which it is used. By float it is meant that the serum will remain at the surface of the laundry liquid for a period of at least 5 minutes, preferably 10 minutes and most preferably at least 15 minutes. Floating provides the benefit the laundry liquid carries the serum into the laundry process. To enable the serum to float, it is not essential that it is less dense than the laundry liquid with which it is being used, however it is preferred that the serum is less dense than the laundry liquid with which it is used. This density provides the benefit the laundry liquid carries the serum into the laundry process. The laundry serum composition is preferably not miscible with a laundry liquid with which it is used. The in-admissibility prevents mixing of the laundry serum composition and laundry liquid and ensures maximum performance of the serum.

Throughout this specification viscosity measurements were carried out at 25° C., using a 4 cm diameter 2° cone and plate geometry on a DHR-2 rheometer ex. TA instruments.

In detail, all measurements were conducted using a TA-Instruments DHR-2 rheometer with a 4 cm diameter 2 degree angle cone and plate measuring system. The lower Peltier plate was used to control the temperature of the measurement to 25° C. The measurement protocol was a ‘flow curve’ where the applied shear stress is varied logarithmically from 0.01 Pa to 400 Pa with 10 measurement points per decade of stress. At each stress the shear strain rate is measured over the last 5 seconds of the 10 second period over which the stress is applied with the viscosity at that stress being calculated as the quotient of the shear stress and shear rate.

For those systems which exhibit a low shear viscosity plateau over large shear stress ranges, to at least 1 Pa, the characteristic viscosity is taken as being the viscosity at a shear stress of 0.3 Pa. For those systems where the viscosity response is shear thinning from low shear stress the characteristic viscosity is taken as being the viscosity at a shear rate of 21 s-1.

The ancillary composition and laundry detergent may be added to the drum of the washing machine in a variety of different ways, for example they may be poured directly into the washing machine or they may be added to the drum in a dosing ball. Preferably the ancillary composition and detergent are added to the drum in a dosing ball. For example the laundry detergent may be poured into the dosing ball and the ancillary composition poured on top.

A dosing ball is taken to mean any form of container which would usually hold a laundry detergent composition and be placed directly in a washing machine. The contents of the dosing ball is washed out of the dosing ball during the wash cycle.

In a preferred embodiment the ancillary laundry composition is added to the laundry process in a volume of 2-100 ml, more preferably a volume of 2-50 ml.

In the case of silicones, preferably the composition comprises more than 4 wt. % of the total composition of (c).

Preferably the ancillary laundry agent (c) is contained in a squeeze or pump dispenser having a narrow dispensing orifice. Preferably the dispensing orifice is less than 10 mm. Preferably the dispensing orifice is narrower than the orifice of the dispenser for (b) and preferably also than (a). Preferably ancillary laundry agent has a viscosity greater than (b) and preferably also greater than (a). Preferably ancillary laundry agent viscosity is greater by at least 500 centipoise.

Preferably the either (a) or (b) are liquid and the method of dosing the ancillary laundry agent comprises the following steps:
i. pouring component (a) or (b) into a washing machine draw or a dosing shuttle, and then
ii. pouring the ancillary laundry composition on top of (a) or (b).

Preferably, the ancillary laundry composition is poured on top of (b), the fabric conditioner.

The advantage of this arrangement is that the ancilliary product floats and is carried through to the wash or rinse liquor along with the ‘carrier’ liquid.

Preferably component (d) comprises a fabric refresher comprising: a fabric refreshing composition; and a hand-held spray device which is manually operable to produce a spray of said composition in the form of a fine aerosol; said composition comprising at least one of: an anti-malodour agent, an anti-wrinkle agent, and a perfume; and said spray device comprising a reservoir containing said composition and a spray mechanism.

Preferably the spray device is adapted for more effective and convenient operation by the provision of a shroud surrounding the spray mechanism, the shroud being aligned with the reservoir of the device.

Preferably the shroud is elongate and the spray direction of the device is substantially orthogonal to a longitudinal axis of the shroud.

Preferably the spray mechanism has a discharge orifice which is configured to produce a fine aerosol spray having a comparatively large cone angle, suitably in the range of 55 to 80 degrees.

Preferably the spray mechanism is configured to produce a fine aerosol having a small average droplet size, suitably in the range of 20 to 200 μm.

Garment Refreshing Composition

The garment refreshing composition can be in any physical form, for example a solid such as a powder or granulate; or as a liquid such as an aqueous liquid. Solid forms could be mixed with water prior to spraying. A liquid is preferred.

Preferably the garment refreshing composition comprises at least two components, i.e. an anti-malodour agent and an anti-wrinkle agent; or an anti-malodour agent and a perfume; or an anti-wrinkle agent and a perfume. Most preferably all three, anti-wrinkle agent; anti-malodour agent and perfume, are present.

The garment refreshing composition suitably includes a carrier, which conveniently can be water.

The garment refreshing composition suitably contains encapsulated perfume, for example perfume encapsulates, e.g. perfume microcapsules. Preferably the capsules are rupturable melamine-formaldehyde polymeric wall.

Any suitable anti-malodour agent may be used. Indeed, an anti-malodour effect may be achieved by any compound or product that is effective to “trap”, “absorb” or “destroy” odour molecules to thereby separate or remove odour from the garment.

The odour control agent may be selected from the group consisting of: uncomplexed cyclodextrin; odour blockers; reactive aldehydes; flavanoids; zeolites; activated carbon; and mixtures thereof.

As noted above, a suitable anti-malodour agent is cyclodextrin, suitably water soluble uncomplexed cyclodextrin. Suitably cyclodextrin is present at a level selected from 0.01% to 5%, 0.1% to 4%, and 0.5% to 2% by weight of the garment refreshing composition.

As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings. P

Preferably the anti-malodour is water soluble. A commercially available water soluble cyclodextrin is available, e.g., from Cerestar U.S.A., Inc. and Wacker Chemicals (U.S.A.), Inc.

Suitably the garment refreshing composition contains a silicone anti-wrinkle agent.

Suitable silicone polymers are emulsified silicones are disclosed at paragraph 34 of US20050113282A1 as having the formula: (CH₃)₃SiO[(CH₃)₂SiO]mSi(CH₃)₂ wherein m is in the range of from 1 to 8. Other useful silicone polymers disclosed are polydimethyl siloxanes as disclosed in U.S. Pat. No. 6,001,343 at Column 29, lines 1-25.

Suitably, the composition comprises silicone phospholipid polymer additive(s) as exemplified in U.S. Pat. No. 5,237,035, examples 56-85 at column 12, at a rate of 0.05% to 0.8%, preferably 0.1-0.3% and most preferably, 0.2%.

The composition may comprise a water soluble silicone as disclosed in US2002148994 by Giuvudan which is hereby incorporated by reference. The silicone is of the formula I:

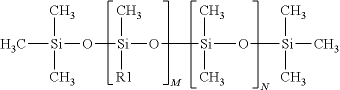

Wherein M is 40 to 200, N is 0 to 20, and R1 is a polyethylene or a polypropylene ether.

Suitably the silicone is a dimethicone copolyol. Suitably the silicone is a dimethicone copolyol which is a polymer of dimethyl siloxane with polyoxyethylene and/or polyoxypropylene side chains.

The water-soluble silicone may contain at least one, preferably at least two dimethicone copolyols. The dimethicone copolyol suitably has a surface activity that enables it to wet and penetrate the fiber. The preferred polymer is one that has an ethylene oxide to propylene oxide ratio (“EO/PO”) greater than 20/80, preferably greater than 40/60, and a surface tension in a 0.1% solution in water at 25[deg.] C. of less than 25 mN/m. Examples of dimethicone copolyols that may be used in the present invention include the TEGOPREN® nonionic series marketed by Goldschmidt Corporation (Hopewell, Va.).

Refresh Dose

Conveniently, the garment refreshing composition is provided as a liquid, and said spray mechanism is operable to discharge a dose of at least 0.1 ml, preferably at least 0.2 ml, more preferably at least 0.25 ml, more preferably at least 0.3 ml, more preferably at least 0.35 ml, more preferably at least 0.35 ml, more preferably at least 0.4 ml, more preferably at least 0.45 ml, and most preferably at least 0.5 ml.

Suitably the dose is no more than 2 ml, preferably no more than 1.8 ml, preferably no more than 1.6 ml, more preferably no more than 1.5 ml, more preferably no more than 1.4 ml, more preferably no more than 1.3 ml, and most preferably no more than 1.2 ml.

Suitably the dose is between 0.1 and 2 ml of said liquid garment refreshing composition, preferably between 0.2 and 1.8 ml, more preferably 0.25 to 1.6 ml, more preferably 0.25 to 1.5 ml, and most preferably 0.25 to 1.2 ml.

These doses have been found to be particularly effective at achieving the desired garment refresh effect (for example anti-wrinkle) without unsightly and wasteful large droplet formation.

### DESCRIPTION OF EXAMPLES

So that the invention may be more readily understood, and so that further features thereof may be appreciated, embodiments of the invention will now be described by way of example and with reference to the accompanying drawings in which:

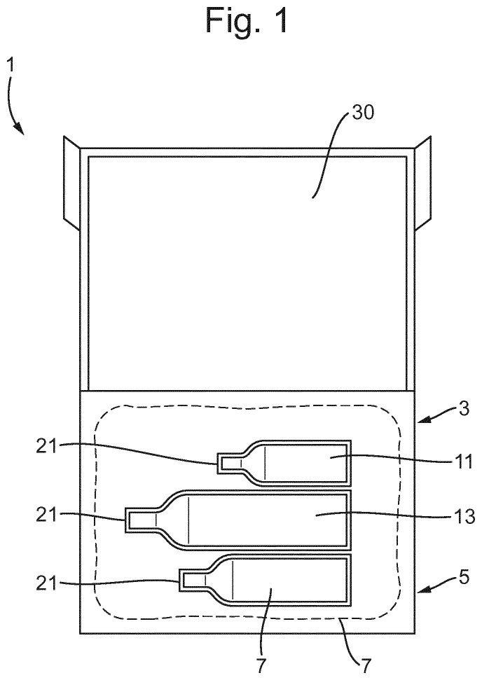

FIG. 1 is a plan view of a package according to one aspect of the invention

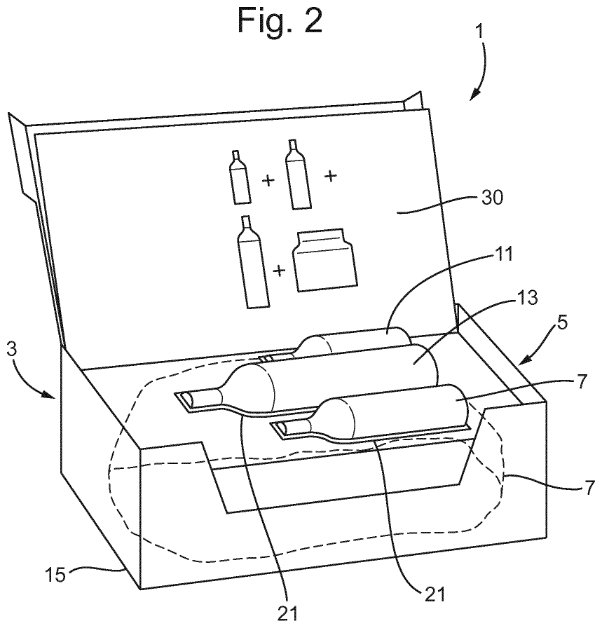

FIG. 2 is an enlarged perspective view of the package shown in FIG. 1.

The exemplary system 1 comprises an outer package 3 comprising a box 5 in which the following components are contained:

(a) a pouch indicated at 7 containing a plurality of water soluble capsules (not shown) containing unit doses of non-biological (enzyme free) detergent composition,

(b) a bottle 9 containing a liquid fabric rinse conditioner (not shown) comprising a perfume and a colour care agent

(c) a squeezable dispensing bottle 11 containing a laundry anciliary liquid (not shown) in the form of a serum which comprises a fabric shape retention agent and fabric drape improver,

(d) a non-aerosol sprayer 13 containing a fabric refresh spray.

The box 5 is designed having a flat base 15 to be placed on a countertop or similar. For example, it may be placed on a countertop in a kitchen or utility room, or may be placed on top of a washing machine for ease of access.

The box and all the complementary laundering components bear common visual indicia 17 and corresponding instructions to launder fabrics with system components (a) and (b) and (c) and (d). An inlay card 30 summarises the instructions.

The complementary laundering components are stored in the box 5 in a layered manner, such that the pouch 7 of capsules forms one layer and the bottles 9, 11, 13 of fabric conditioner, serum and refresh spray are carried by a tray 19 above the capsules pouch. The tray has recesses 21 and each bottle is stored in a respective recess. In this way the flexible pouch can nest in the areas between the recesses. This configuration affords a pleasing experience for the consumer whilst ensuring greater stability in transit particularly for postal delivery direct to the consumer. In further embodiments the capsules are rigid and this further improves the stability of the pack for transport.

The squeeze or pump dispenser 11 has a narrow dispensing orifice not shown, which is preferably less than 10 mm and suitably 3 mm. This orifice is narrower than the orifice (not shown) of the dispenser bottle 9 for the fabric rinse conditioner liquid.

The fabric refresher 13 comprises a hand-held spray device which is manually operable to produce a spray of said refresh composition in the form of a fine aerosol. In in further embodiments, not shown, the spray device 13 is adapted for more effective and convenient operation by the provision of a shroud surrounding the spray mechanism, the shroud being aligned with the reservoir of the device. The shroud is elongate and the spray direction of the device is substantially orthogonal to a longitudinal axis of the shroud.

The spray mechanism has a discharge orifice is configured to produce a fine aerosol spray having a comparatively large cone angle, suitably in the range of 55 to 80 degrees.

The spray mechanism is configured to produce a fine aerosol having a small average droplet size, suitably in the range of 20 to 200 μm.

Illustrative compositions suitable for use in the devices of FIGS. 1 to 2 include one or more of the following.

Laundry Detergent Composition

As described below in Table 1

Laundry Fabric Conditioning Composition

Compositions A and B below were made by adding a melt comprising the fabric softening active (TEAQ) to a heated (about 40-60° C.) aqueous phase comprising the minors, perfume microcapsules, acid and antifoam. A proportion of CaCl₂) was added to the water before the addition of the melt to the water, and the remaining CaCl₂) was added after the addition of the melt. Free oil perfume was then added upon cooling.

TABLE 1
Fabric Conditioning Compositions

| | Amount (wt % by wt | |
|---|---|---|
| | perfume in the encap) | |
| Ingredient | Composition A | Composition B |
| TEAQ¹ | 20 | 20 |
| Antifoam² | 0.02 | 0.02 |
| Hydrochloric acid | 0.03 | 0.03 |
| CaCl₂ | 0.21 | 0.21 |
| Perfume V | 1.04 | — |
| Perfume W | — | 1.31 |
| ⁵Microcapsule Type 2, perfume Z | 0.35 | 0.325 |
| ⁴Microcapsule Type 1, perfume X | 0.35 | — |
| ⁴Microcapsule Type 1, perfume Y | — | 0.325 |
| water & minors³ | balance | balance |

¹Softening active - Palm based soft TEA Quat; ex Stepan
²Comprising silicone; Ex Basildon
³Preservative, sequestrant
⁴Microcapsule Type 1 = cured for 1 hr at 125° C.
⁵MicroCapsule Type 2 = cured for 1 hr at 80° C.

Microcapsule Preparation.

The following procedure was used to prepare the microcapsules as used in these examples:—

Fragrance was admixed with NEOBEE-M5 and 40% ethylene urea solution thereby forming a fragrance/solvent composition. The uncoated capsules were prepared by creating a polymeric wall to encapsulate the fragrance/solvent composition droplets. To make the microcapsule slurry, a co-polyacrylamide/acrylate (ALCAPSOL 200) was dispersed in water together with a high imino methylated melamine crosslinker (CYMEL 385, Cytec Industries, Belgium). The microcapsule components were allowed to react under acidic conditions. The fragrance/solvent composition was then added into the solution and droplets of the desired size were achieved by high shear homogenization.

Composition of the resulting microcapsules is shown in Table 2 below.

TABLE 2
Composition of core and wall of microcapsules prepared as described
above.

| | |
|---|---|
| Component | Weight % |

Core

| | |
|---|---|
| Fragrance | 28 |
| NEOBEE-M5 | 7 |
| 40% Ethylene Urea Solution | 5.7 |

Wall

| | |
|---|---|
| ALCAPSOL 200 | 5.7 |
| 3.1% CYMEL 385 | 3.1 |

In this way, two different types of microcapsules were produced, Type 1 and Type 2, which differed in the fragrance composition (as shown in Table 3) and also the curing temperature: Type 1 was cured for 1 hour at 125° C. and Type 2 was cured for 1 hour at 80° C. Microcapsules prepared as described above are summarized in Table 1.

TABLE 3
Composition of fragrance used to prepare Type 1 and Type 2
microcapsules.

| | | Oil with High | Oil with Low |
|---|---|---|---|
| | | saturated apor | Saturated vapor |
| | Fragrance | vpressure at 23° C. | pressure at 23° C. |
| | Commercial | (>0.01 mmHg) | (<0.01 mmHg) |
| Microcapsule | name | [wt %] | [wt %] |
| Type 1 | Jillz* | 81% | 18% |
| Type 2 | Greenfields* | 53% | 46% |

*Fragrance commercially available from International Flavors & Fragrances Inc.

Type 1 and Type 2 microcapsules had different curing times and different perfume component oils.

Laundry Ancillary Composition As described below in Table 1.

Refresh Composition:

0.01 to 5 wt % anti-malodour compound (e.g. cyclodextrin or zinc ricinoleate)

0.01 to 2% surfactant

0.001 to 0.8% antimicrobial

0.01 to 3% low molecular weight polyol

0.001 to 0.3% aminocarboxylate chelator

0.1 to 10% metallic salt

0.0001 to 0.5% enzyme

0.0001 to 0.5% antimicrobial preservative

0.1 to 2.5 wt % anti-wrinkle compound (e.g. a silicone anti-wrinkle compound)

0.001 to 5 wt % perfume (especially encapsulated perfume such as PMCs)

Balance: water

Experimental

Method of Preparing Example Laundry Formulations:

Water and hydrotropes were mixed together at ambient temperature for 2-3 minutes at a shear rate of 150 rpm using a Janke & Kunkel IKA RW20 overhead mixer. Salts and alkalis were added and mixed for 5 minutes prior to addition of surfactants and fatty acid. The mixture was exothermic and allowed to cool to <30° C. The deposition polymer² (when present), silicone emulsion¹ (when present) and any remaining components such as perfume, preservatives and dyes are added.

Method of Producing Example Serum:

Demineralised water was added to the silicone emulsion¹ and mixed for 15 mins at 250 rpm using a Janke & Kunkel IKA RW20 overhead mixer. The solid deposition polymer² was added slowly over the top and mix for further 20 mins increasing the rotor speed to effect visible bulk mixing.

TABLE 1
Example Compositions

| | Laundry detergent | Laundry detergent | Serum |
|---|---|---|---|
| | with silicone | without silicone | Composition |
| Ingredient | (w.t. %) | (w.t. %) | (w.t. %) |
| Glycerol | 3.5 | 3.5 | — |
| TEA | 1.25 | 1.25 | — |
| Citric acid | 1.0 | 1.0 | — |
| Neodol 25-7 | 4.75 | 4.75 | — |
| LAS acid | 4.0 | 4.0 | — |
| Fatty Acid | 0.7 | 0.7 | — |
| Lauryl ether | 2.0 | 2.0 | — |
| sulphate - Sodium | | | |
| salt | | | |
| Silicone¹ | 0.6 | 0 | 5 |
| Deposition polymer² | 0.3 | 0 | 2 |
| NaOH | to pH 8-8.5 | to pH 8-8.5 | to pH 7-8 |
| Minors | <5 | <5 | <5 |
| Water | to 100 | to 100 | to 100 |

Silicone¹ - Silicone added as a 30% emulsion ex. Wacker Silicone. The silicone comprised a carboxy group in a mid-chain pendent position.
Deposition polymer² - Ucare ™ polymer LR400 ex. Dow

Comparison of Formulations:

A wash cycle was carried out using 6 (20 cm×20 cm) pieces of terry towelling and a polycotton ballast. The total wash load was 2.0 kg. The towelling was mixed with the ballast fabric in a random order before adding into a Miele front loading washing machine. Detergent was added as follows:

Wash A: 100 g Laundry detergent with silicone

Wash 1: 100 g Laundry detergent without silicone and 10 g serum to the wash drawer

The machine was programmed to a standard 40° C. cotton cycle. The towelling swatches were line dried between wash cycles. 5 wash cycles were performed.

The towels were measured for softness using a Phabrometer® ex. Nu Cybertek, Inc.

TABLE 2
Softness measurements results

| | Average softness | Standard deviation |
|---|---|---|
| Pre-wash sample | 9.887 | 0.272 |
| Wash A | 9.654 | 0.155 |
| Wash 1 | 9.193 | 0.220 |

Despite having slightly lower levels of silicone and deposition polymer in Wash 1, the fabric is significantly softer.

When used in this specification and claims, the terms “comprises” and “comprising” and variations thereof mean that the specified features, steps or integers are included. The terms are not to be interpreted to exclude the presence of other features, steps or integers.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

1. An anti-aging laundering system for fabrics comprising complementary laundering system components:
(a) a detergent composition,
(b) a fabric rinse conditioner, and
(c) an ancillary laundry agent,
wherein the (b) or (c) provides a combination of:
(i) a fabric shape retention agent,
(ii) a fabric drape improver,
(iii) at least one perfume,
wherein said complementary laundering components bear common visual indicia and corresponding instructions to launder fabrics with components (a) and (b) and (c);
wherein the system further includes a further complementary component being a fabric refresh spray, which also bears said common visual indicia;
wherein the system includes instructions to treat the fabrics with the fabric refresh spray following use of said laundered fabrics, and then subsequently to re-wear the laundered fabrics; and
wherein the fabric refresher comprises a fabric refreshing composition and a hand-held spray device which is manually operable to produce a spray of said composition in the form of a fine aerosol; said composition comprising at least one of: an anti-malodour agent, an anti-wrinkle agent, and a perfume; and said spray device comprising a reservoir containing said composition and a spray mechanism.

2. (canceled)

3. An anti-aging laundering system for fabrics according to claim 1, wherein the laundering system includes a further complementary component being at least one colour care agent.

4. An anti-aging laundering system for fabrics according to claim 1, wherein said laundering system components are provided in outer packaging which connects the components but more preferably wholly or partly encloses said components.

5. An anti-aging laundering system for fabrics according to claim 1, wherein the detergent composition comprises one or more unit doses.

6. An anti-aging laundering system for fabrics according to claim 1, wherein the fabric rinse conditioner comprises at least 8 wt % of a fabric conditioning active.

7. An anti-aging laundering system for fabrics according to claim 1, wherein the ancilliary laundry agent comprises the combination of a shape retention agent and drape improver.

8. An anti-aging laundering system for fabrics according to claim 1, wherein shape retention agent and drape improver comprise a silicone.

9. An anti-aging laundering system for fabrics according to claim 1, wherein the components are contained in dispensers having respective dispensing orifices, said ancillary laundry agent being contained in a squeeze or pump dispenser having a narrower dispensing orifice than the orifice of the dispenser for (b) and preferably also than (a).

10. (canceled)

11. An anti-aging laundering system for fabrics according to claim 1, wherein the anti-malodour agent is selected from the group consisting of: uncomplexed cyclodextrin; odour blockers; reactive aldehydes; flavanoids; zeolites; activated carbon; and mixtures thereof.

12. An anti-aging laundering method for fabrics comprising the steps of:
(a) selecting from an anti-aging system comprising complementary components
(i) detergent composition,
(ii) fabric rinse conditioner, and
(iii) laundry ancilliary liquid
wherein the (b) or (c) provides a combination of:
(a) a fabric shape retention agent,
(b) a fabric drape improver, and
(c) at least one perfume,
and wherein said complementary laundering components bear common visual indicia
(b) carrying out an aqueous washing operation in which (i) detergent composition, (ii) a fabric rinse conditioner, and (iii) an ancilliary laundry agent are added to a wash liquor,
(c) laundering said fabrics, and
(d) refreshing the laundered fabrics after use with refresh spray (d).

13. An anti-aging laundering method for fabrics according to claim 12, further comprising the step of adding the laundry ancillary liquid via a dosing device.

14. A anti-aging laundering method for fabrics according to claim 12 wherein either (a) detergent composition or (b) fabric rinse conditioner are liquid, and wherein the method of dosing the ancillary laundry agent comprises the following steps:
i. pouring liquid (a) or (b) into a washing machine draw or a dosing shuttle, and then
ii. pouring the ancillary laundry composition on top of (a) or (b).

15. A anti-aging laundering method for fabrics and/or system substantially as in herein described.
